(19) United States
(12) Patent Application Publication
(10) Pub. No.: US 2009/0081081 A1
(43) Pub. Date: Mar. 26, 2009

(54) PIPETTE TIP SUPPLIER AND SAMPLE ANALYZER

(75) Inventors: Takeo KOWARI, Kobe-shi (JP); Takayoshi Izumi, Kobe-shi (JP)

Correspondence Address: SUGHRUE MION, PLLC, 2100 PENNSYLVANIA AVENUE, N.W., SUITE 800, WASHINGTON, DC, 20037, US

(73) Assignee: SYSMEX CORPORATION, Kobe-shi (JP)

(21) Appl. No.: 12/203,720

(22) Filed: Sep. 3, 2008

(30) Foreign Application Priority Data
Sep. 20, 2007 (JP) 2007-243972

(51) Int. Cl. G01N 35/10; B01L 11/00

(52) U.S. Cl. 422/63; 422/99

(57) ABSTRACT

The present invention is to present a pipette tip supplier and a sample analyzer which are capable of increasing an efficiency of eliminating electrification charge of the pipette tip than ever before. The pipette tip supplier comprises: a tip supply mechanism section 32 for containing pipette tips 3; a tip storing section 34 for storing pipette tips 3 supplied from the tip supply mechanism section 32; a static eliminator fan 33 for performing an eliminating operation for eliminating electrification charge of the pipette tips 3 being stored in the tip storing section 34; and a separating mechanism section 36 for performing a separating operation for separating the pipette tips 3 being stored in the tip storing section 34 one by one.

### FIELD OF THE INVENTION

The present invention relates to pipette tip suppliers and sample analyzers, in particular to a pipette tip supplier equipped with a static eliminator for eliminating electrification charges of the pipette tip, and a sample analyzer

### BACKGROUND

Conventionally, a sample analyzer equipped with a dispensing nozzle for aspirating and discharging liquid such as sample and reagent, capable of being removably attached with a disposable pipette tip at a distal end of the dispensing nozzle to prevent pollution is known. In such analyzer, a pipette tip supplier for supplying the pipette tip one by one to the dispensing nozzle is generally arranged so that the dispensing operation can be successively performed. Various pipette tip suppliers have been conventionally proposed.

Japanese Laid-Open Patent Publication No. 2007-178190 discloses a pipette tip supplier equipped with a containing section containing a plurality of pipette tips and having a sending part for sending one part of the plurality of container pipette tips, a transport path for transporting the pipette tip sent by the sending part, and a static eliminator fan (static eliminator) for removing electrification charges of the pipette tip passing through the transport path; and a sample analyzer. The pipette tip in Japanese Laid-Open Patent Publication No. 2007-178190 generates static electricity by friction between the pipette tips in the containing section. The static eliminator fan of the pipette tip supplier in Japanese Laid-Open Patent Publication No. 2007-178190 is configured to blow ionized air towards the transport path, so that the electrification charge of the pipette tip is eliminated by blowing ionized air to the pipette tip when the pipette tip passes (moves) through the transport path.

However, in the pipette tip supplier of the sample analyzer disclosed in Japanese Laid-Open Patent Publication No. 2007-178190, the period in which the ionized air is blown to the charged pipette tip is limited to a short period of time in which the pipette tip passes (moves) through the transport path, and thus there is a drawback in that it becomes difficult to sufficiently eliminate the electrification charge of the pipette tip. Thus, it is sometimes difficult to separate the pipette tip one by one as the pipette tips attract to each other, whereby it becomes difficult to supply the pipette tip to the dispensing nozzle one by one. Furthermore, even after the pipette tips are separated, the pipette tips attract to each other if the pipette tips are charged, and thus it becomes difficult to supply the pipette tip to the dispensing nozzle one by one.

The present invention has been developed in view of the above aspects and is to present a pipette tip supplier and a sample analyzer which are capable of increasing an efficiency of eliminating electrification charge of the pipette tip than ever before.

### SUMMARY

A first aspect of the present invention is a pipette tip supplier, comprising: a containing section for containing pipette tips for aspirating samples; a storing section for storing pipette tips supplied from the containing section; a static eliminator for performing an eliminating operation for eliminating electrification charge of the pipette tips being stored by the storing section; and a separator for performing a separating operation for separating the pipette tips being stored by the storing section one by one.

A second aspect of the present invention is a sample analyzer, comprising: a containing section for containing pipette tips for aspirating samples; a storing section for storing pipette tips supplied from the containing section; a static eliminator for performing an eliminating operation for eliminating electrification charge of the pipette tips being stored by the storing section; a separator for performing a separating operation for separating the pipette tips being stored by the storing section one by one; a dispenser comprising an aspirating nozzle to which the pipette tip separated by the separator is attachable, and for dispensing a sample with the pipette tip attached to the aspirating nozzle; and an analyzing section for analyzing the sample dispensed by the dispenser.

A third aspect of the present invention is a pipette tip supplier, comprising: a containing section for containing pipette tips for aspirating samples, and comprising a sending port for sending the contained pipette tips; a storing section being arranged at a lower side of the sending port, and for storing the pipette tips sent from the containing section through the sending port; a separator being arranged adjacent to the storing section, and for performing a separating operation for separating the pipette tips being stored by the storing section one by one; and a static eliminator being arranged at an upper side of the sending port, and comprising: a lid for substantially closing a space formed by the sending port, the storing section and the separator; an ionizer for generating ion; and a fan for blowing air containing the ion generated by the ionizer to the sending port, the storing section and the separator.

A fourth aspect of the present invention is a sample analyzer, comprising: a containing section for containing pipette tips for aspirating samples, and comprising a sending port for sending the contained pipette tips; a storing section being arranged at a lower side of the sending port, and for storing the pipette tips sent from the containing section through the sending port; a separator being arranged adjacent to the storing section, and for performing a separating operation for separating the pipette tips being stored by the storing section one by one; and a static eliminator being arranged at an upper side of the sending port, and comprising: a lid for substantially closing a space formed by the sending port, the storing section and the separator; an ionizer for generating ion; and a fan for blowing air containing the ion generated by the ionizer to the sending port, the storing section and the separator; a dispenser comprising an aspirating nozzle to which the pipette tip separated by the separator is attachable, and for dispensing a sample with the pipette tip attached to the aspirating nozzle; and an analyzing section for analyzing the sample dispensed by the dispenser.

### BRIEF DESCRIPTION OF THE DRAWINGS

FIG. 1 is a plan view showing an overall configuration of an immune analyzer equipped with a pipette tip supplier according to one embodiment of the present invention;

FIG. 2 is a front view of a pipette tip supplied by the pipette tip supplier according to one embodiment of the present invention;

FIG. 3 is a block diagram showing a configuration of a measurement unit of the immune analyzer shown in FIG. 1;

FIG. 4 is a block diagram showing a configuration of a controller of the measurement unit of the immune analyzer shown in FIG. 1;

FIGS. 5 and 6 are perspective views showing an urgent sample transport section of the immune analyzer shown in FIG. 1;

FIG. 7 is a perspective view showing an overall configuration of the pipette tip supplier according to one embodiment of the present invention;

FIG. 8 is a cross sectional view showing an overall configuration of the pipette tip supplier according to one embodiment shown in FIG. 7;

FIG. 9 is a front view showing an overall configuration of the pipette tip supplier according to one embodiment shown in FIG. 7;

FIG. 10 is a perspective view of the pipette tip supplier according to one embodiment shown in FIG. 7 seen from a tip supply mechanism section side;

FIG. 11 is a perspective view of the pipette tip supplier according to one embodiment shown in FIG. 7 seen from the tip supply mechanism section side;

FIGS. 12 and 13 are views describing a structure of the periphery of a tip storing section and a separating mechanism section of the pipette tip supplier according to one embodiment shown in FIG. 7;

FIG. 14 is a plan view of a transfer section of the pipette tip supplier according to one embodiment shown in FIG. 7;

FIG. 15 is a side view of the transfer section of the pipette tip supplier according to one embodiment shown in FIG. 7;

FIG. 16 is a front view of a cuvette used in the immune analyzer shown in FIG. 1;

FIG. 17 is a side view of an urgent sample transport section and sample dispensing arm of the immune analyzer shown in FIG. 1;

FIGS. 18 and 19 are side views showing a state in which the pipette tip is attached to the sample dispensing arm of the immune analyzer shown in FIG. 1;

FIG. 20 is a side view showing a state in which the pipette tip is detached from the sample dispensing arm of the immune analyzer shown in FIG. 1;

FIG. 21 is a block diagram showing a configuration of a data processing unit of the immune analyzer apparatus shown in FIG. 1;

FIG. 22 is a flowchart describing a process flow of supplying the pipette tip stored in the tip storing section of the pipette tip supplier of immune analyzer shown in FIG. 1 to the transfer section; and

FIG. 23 is a flowchart describing the details of the separating process executed in the flowchart shown in FIG. 22.

### DETAILED DESCRIPTION OF THE PREFERRED EMBODIMENTS

The embodiments of the present invention will be described based on the drawings.

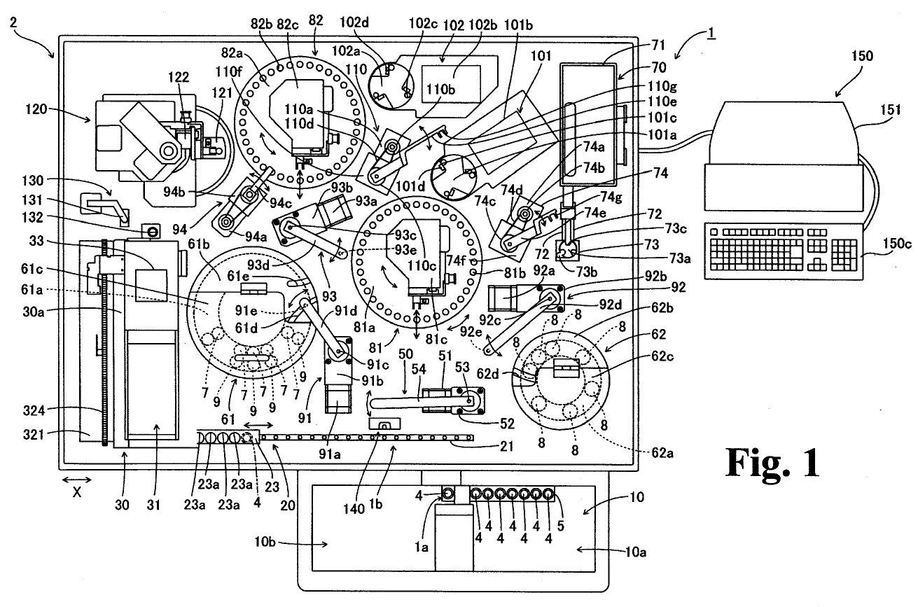

A configuration of an immune analyzer equipped with a pipette tip supplier according to one embodiment of the present invention will be described first with reference to FIGS. 1 to 21.

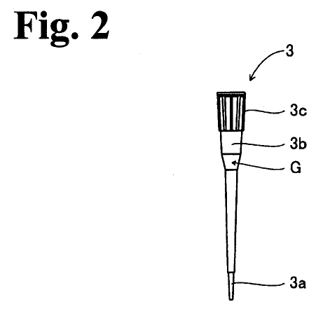

An immune analyzer 1 equipped with a pipette tip supplier 30 according to one embodiment of the present invention is an apparatus for carrying out examinations on various items such as hepatitis B, hepatitis C, tumor marker, and thyroid hormone using sample such as blood. As shown in FIG. 1, the immune analyzer 1 is mainly configured by a measurement unit 2 having a function of measuring blood or the sample, and a data processing unit 150 for analyzing the measurement result output from the measurement unit 2 and obtaining an analysis result. The measurement unit 2 is configured by a sample transport section (sampler) 10, an urgent sample/tip transport section 20, a pipette tip supplier 30, a sample dispensing arm 50, reagent installing members 61 and 62, a cuvette supply member 70, a primary reaction member 81 and a secondary reaction member 82, reagent dispensing arms 91, 92, 93, and 94, BF separators 101 and 102, a transport catcher section 110, a detector 120, a waste member 130, and a tip detachment member 140. In the immune analyzer 1 according to the present embodiment, the disposable pipette tip 3 (see FIG. 2) is changed every time aspiration and discharge of sample are performed in order to suppress the sample such as blood aspirated and discharged by the sample dispensing arm 50 from mixing with other sample.

In the measurement unit 2 of the immune analyzer 1, the sample such as blood containing antigen to be measured and a trapped antibody (R1 reagent), and magnetic particles (R2 reagent) are mixed, and then the antigen, the trapped antibody and the magnetic particles are bonded, and thereafter, the magnetic particles are attracted to a magnet 101d of the BF (Bound Free) separator 101 to remove solution containing non-reactive (free) trapped body. A labeled antibody (R3 reagent) is bonded to the magnetic particles bound with antigen, and thereafter, the bound magnetic particles, the antigen, and the labeled antibody are attracted to a magnet 102d of the BF separator 102 to remove the R3 reagent containing non-reactive (free) labeled antibody. Furthermore, a luminescent substrate (R5 reagent) that emits light in the reaction process with the labeled antibody is added, and thereafter, a light emission amount generated through the reaction of the labeled antibody and the luminescent substrate is measured. Through such processes, the antigen contained in the sample that bonds with the labeled antibody is quantitatively measured.

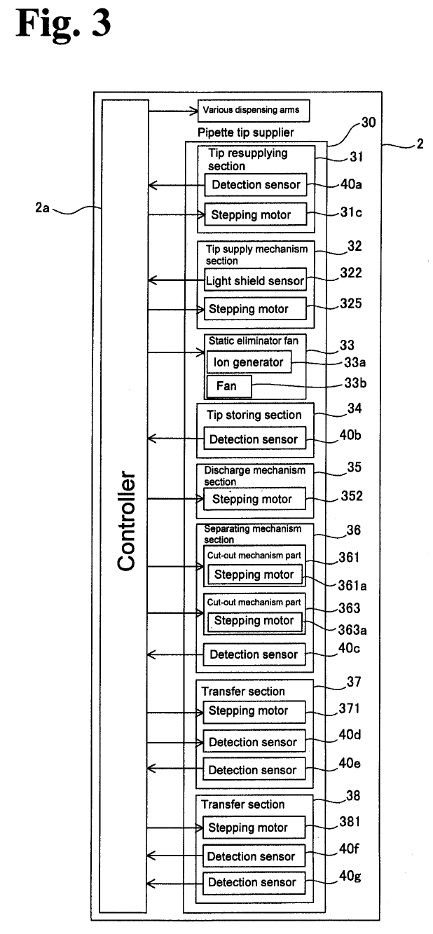

As shown in FIG. 3, each mechanism (various dispensing arms, pipette tip supplier 30 etc.) in the measurement unit 2 are controlled by a controller 2a arranged in the measurement unit 2. For instance, the controller 2a receives signals of various sensors (detection sensor (transmissive sensor) 40a to 40g etc. to be hereinafter described) arranged in the pipette tip supplier 30, and controls the drive of various drive sources (stepping motor 361a, stepping motor 363a, etc.) arranged in the pipette tip supplier 30. The urgent sample/tip transport section 20 is also configured to be controlled by the controller 2a. Various dispensing arms, various sensors, and various drive sources will be hereinafter described in detail.

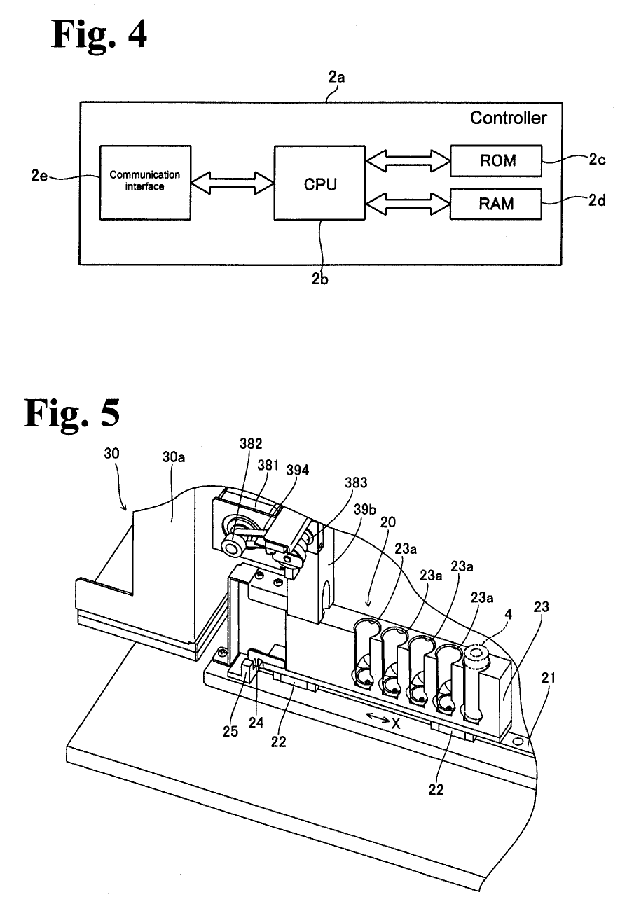

The controller 2a is mainly configured by a CPU 2b, a ROM 2c, a RAM 2d, and a communication interface 2e, as shown in FIG. 4.

The CPU 2b executes computer programs stored in the ROM 2c and the computer programs read out to the RAM 2d. The ROM 2c is recorded with computer programs to be executed by the CPU 2b, data used for the same, and the like. The RAM 2d is used to read out the computer programs recorded on the ROM 2c. The RAM 2d is used as a work region of the CPU 2b when executing the computer programs.

The communication interface 2e is connected to the data processing unit 150 (see FIG. 1), and has a function of transmitting optical information (data of light emission amount generated by the reaction of the labeled antibody and the luminescent substrate) of the sample to the data processing unit 150, and receives signals from a controller 150a, to be hereinafter described, of the data processing unit 150. The communication interface 2e also has a function of transmitting commands from the CPU 2b to drive the urgent sample/tip transport section 20 (see FIG. 1) and each member of the measurement unit 2 (see FIG. 1).

As shown in FIG. 1, the sample transport section 10 is configured to transport a rack 5 mounted with a plurality of test tubes 4 containing the sample to a position corresponding to an aspiration position 1a of the sample dispensing arm 50. The sample transport section 10 includes a rack set section 10a for setting the rack 5 mounted with the test tube 4 containing un-processed sample, and a rack storage section 10b for storing the rack 5 mounted with the test tube 4 containing dispense processed sample. When the test tube 4 containing the non-processed sample is transported to the position corresponding to the aspiration position 1a of the sample dispensing arm 50, the sample such as blood in the test tube 4 is aspirated by the sample dispensing arm 50, and the rack 5 mounted with the relevant test tube 4 is stored in the rack storage section 10b.

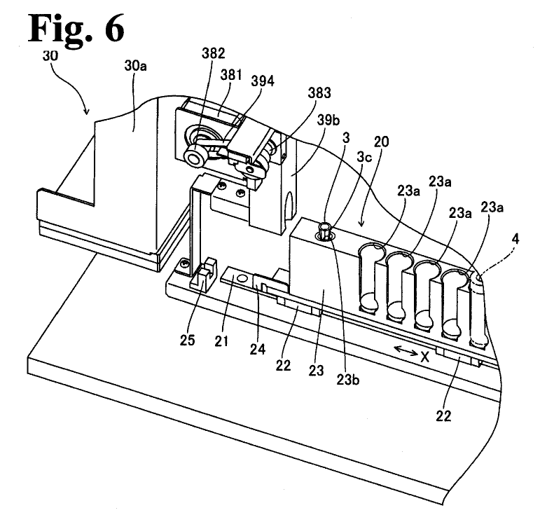

The urgent sample/tip transport section 20 is configured to transport the test tube 4 containing urgent sample that needs to be cut into the sample being transported by the sample transport section 10 for examination to an attachment position 1b of the sample dispensing arm 50. As shown in FIGS. 1, 5, and 6, the urgent sample/tip transport section 20 includes a slide rail 21 arranged to extend in an X-direction, a linear movement guide with a slide body 22 movably arranged along the slide rail 21, a transport rack 23 attached to the slid body 22, a detection strip 24 attached to the lower part of the transport rack 23, and a light shield sensor 25 light shielded by the detection strip 24. The transport rack 23 is arranged with a test tube installing section 23a for installing the test tube 4 containing urgent sample, and a circular hole tip installing section 23b (see FIG. 6) for placing the pipette tip 3 (see FIG. 2) supplied from the pipette tip supplier 30 to be hereinafter described. The detection strip 24 is arranged to light shield the light shield sensor 25 when arranged at a position of receiving the pipette tip 3 from the pipette tip supplier 30. When moved along the slide rail 21 by the driving force from a motor (not shown), the transport rack 23 transports the test tube 4 containing the urgent sample and the pipette tip 3 to the attachment position 1b (see FIG. 1) of the sample dispensing arm 50.

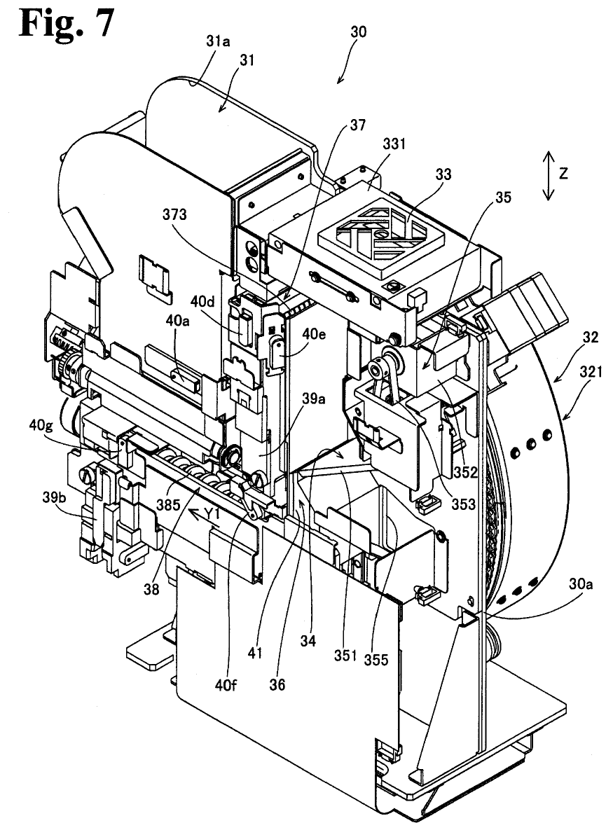

In the present embodiment, the pipette tip supplier 30 has a function of mounting the pipette tip 3 (see FIG. 2) supplied into a tip resupplying section 31, to be hereinafter described, on the tip installing section 23b of the transport rack 23 of the urgent sample/tip transport section 20 one by one. The pipette tip supplier 30 also has a function of supplying the pipette tip to the tip installing section 23b of the transport rack 23 with the distal end 3a (see FIG. 2) of the pipette tip 3 directed downward. As shown in FIGS. 7 to 9, the pipette tip supplier 30 is configured by the tip resupplying section 31, a tip supply mechanism section 32, a static eliminator fan 33, a tip storing section 34, a discharge mechanism section 35, a separating mechanism section 36, a transfer section 37 and a transfer section 38, two chutes 39a, 39b and seven detection sensors (transmissive sensors) 40a to 40g.

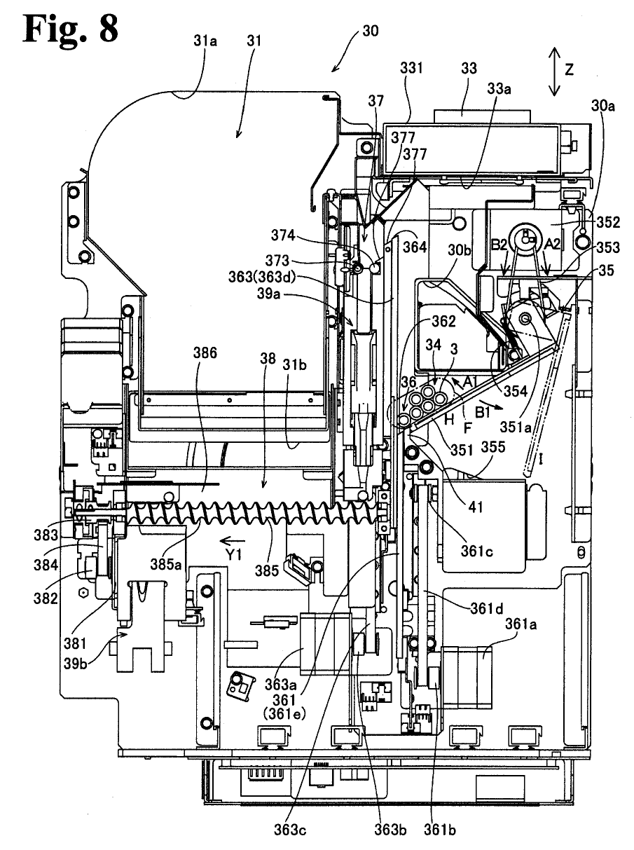

The tip resupplying section 31 is configured to contain a plurality of resupply pipette tips 3 (see FIG. 2). The pipette tip 3 contained in the tip resupplying section 30 is commercially available in a state a plurality (e.g. 500) of pipette tips are bagged. The bagged pipette tips 3 tend to be charged with static electricity of about a few kV (e.g. about 6 kV) due to rubbing between the pipette tips 3 in the transport process of circulating in the market. As shown in FIG. 8, the tip resupplying section 31 includes an insert port 31a for inserting the plurality of pipette tips 3 taken out from the bag, and a discharge port 31b for discharging the container pipette tip 3.

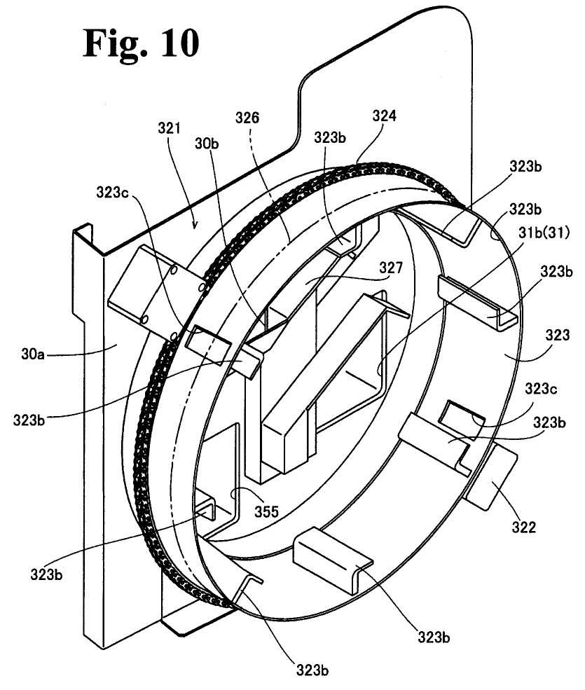

As shown in FIG. 10, the discharge port 31b of the tip resupplying section 31 is configured to guide the pipette tip 3 dropped from the discharge port 31b to a drum 323 of the tip supply mechanism section 32. Specifically, a stepping motor 31c (see FIG. 3) for driving the discharge port 31b in an open/close manner is connected to the discharge port 31b. The stepping motor 31c drives the pipette tip 3 of the tip resupplying section 31 so as to be discharged from the discharge port 31b to the drum 323 of the drum part 321 when determined that the interior of the drum part 321 is not filled with the pipette tip 3 by the output of the light shield sensor 322 of the drum part 321 to be hereinafter described.

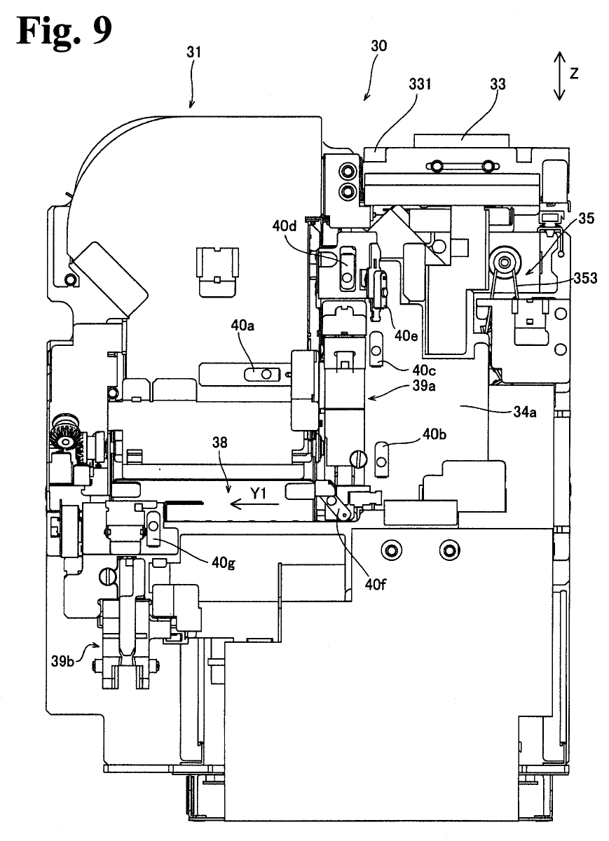

As shown in FIG. 9, a detection sensor (transmissive sensor) 40a for detecting the presence or absence of the pipette tip 3 contained in the tip resupplying section 31 is arranged at a position in the vicinity of the discharge port 31b of the tip resupplying section 31.

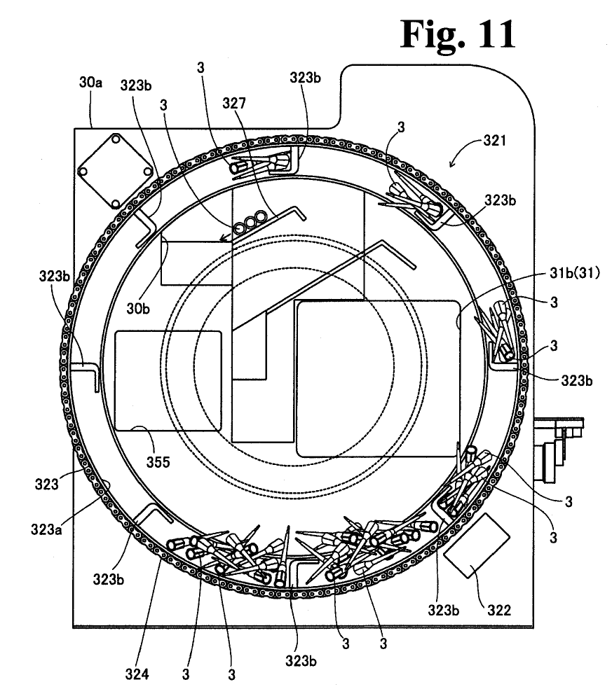

As shown in FIGS. 10 and 11, the tip supply mechanism section 32 has a function of receiving the pipette tip 3 inserted from the discharge port 31b of the tip resupplying section 31, and sending some of the received pipette tips 3 to the tip storing section 34. The tip supply mechanism section 32 is configured by a drum part 321 rotatably attached to a chassis 30a, and a light shield sensor 322 for detecting the rotation position of the drum part 321 and for detecting whether or not the interior of the drum part 321 is filled with the pipette tip 3. The drum part 321 includes a drum 323 with a tubular body capable of containing a plurality of pipette tips 3, a chain 324 wrapped around the outer periphery of the drum 323, a stepping motor 325 (see FIG. 3) for driving the chain 324, and a lid 326 (see FIG. 10) attached on the side opposite to the chassis 30a side so as to block the containing part 323a of the drum 323 of tubular body. A plurality of segmenting parts 323b capable of lifting the pipette tip 3 when the drum part 321 is rotated is arranged on the inner side of the drum 323. The segmenting part 323b has a shape such that the number of pipette tips 3 sent to the tip storing section 34 becomes a predetermined amount (three to five in the present embodiment), and is arranged so that excessive amount of pipette tip 3 is not sent to the tip storing section 34. Therefore, the ionized air blown from the static eliminator fan 33 uniformly hits the pipette tip 3 of the tip storing section 34, thereby effectively removing charges.

The tip supply mechanism section 32 is arranged with a sending part 30b for sending the contained pipette tip 3, and the tip supply mechanism section 32 is configured so that the pipette tip 3 lifted by the segmenting part 323b is sent to the tip storing section 34 through the sending part 30b . A guide part 327 for receiving the pipette tip 3 dropped from the segmenting part 323b is arranged in the vicinity of the sending part 30b of the drum part 321, and the guide part 327 is configured so that the pipette tip 3 slides along the guide part 327 and guided to the sending part 30b.

In the drum 323 of the drum part 321, two windows 323c made of polyvinyl chloride sheet are arranged at a spacing of 180 degrees. The two windows 323c are provided to detect whether or not the pipette tip 3 is left in the drum 321 by the light shield sensor 322. Specifically, if the window 323c is covered by the pipette tip 3, the controller 2a determines that the pipette tip 3 is left inside the drum part 321, and if the window 323c is not covered by the pipette tip 3, the controller 2a determines that the pipette tip 3 is not left inside the drum part 321.

The chain 324 and the drum 323 wrapped with such chain 324 are rotated with the drive of the stepping motor 325 by configuring the drum part 321 as described above. The segmenting part 323b arranged on the inner side of the drum 323 also rotates with the rotation of the drum 323, and accompanied therewith, the pipette tip 3 stored at the lower part of the containing part 323a of the drum 323 is lifted by the segmenting part 323b, and sent to the tip storing section 34 to be hereinafter described through the sending part 30b (see FIG. 8) of the chassis 30a. As the pipette tips 3 contained inside the drum 323 rub against each other by the rotation of the drum 323, static electricity generates at the pipette tip 3.

As shown in FIGS. 7 and 8, the tip storing section 34 is configured by a region surrounded by the separating mechanism section 36, a receiving part 351 of the discharge mechanism section 35, the chassis 30a, and a cover member 34a (see FIG. 9). The tip storing section 34 is configured to store a predetermined amount of pipette tips 3 sent from the sending part 30b of the chassis 30a. The receiving part 351 is arranged so as to incline downward towards the separating mechanism section 36 side. The pipette tip 3 sent from the sending part 30b to the tip storing section 34 is placed on an inclined surface 362 of a cut-out mechanism part 361 when the cut-out mechanism part 361 of the separating mechanism section 36 to be hereinafter described is positioned at the lowermost point (position of FIG. 8). The static eliminator fan 33 is configured to blow ionized air to the separating mechanism section 36 side of the receiving part 351, where the ionized air uniformly hits the pipette tip 3, and the electrification charge of the pipette tip 3 is effectively removed.

The detection sensor (transmissive sensor) 40b (see FIG. 9) for detecting whether or not the pipette tip 3 is stored in the tip storing section 34 is arranged at the position near the separating mechanism section 36 of the receiving part 351. Specifically, the detection sensor 40b is attached to the cover member 34a (see FIG. 9), and is arranged to detect whether or not the pipette tip 3 is placed on the inclined surface 362 of a movement member 361e when the movement member 361e of the cut-out mechanism part 361 of the separating mechanism section 36 to be hereinafter described is positioned on the lower side. When the controller 2a determines that the pipette tip 3 is not present on the inclined surface 362 of the movement member 361e (detection sensor 40b turned OFF), the tip supply mechanism section 32 is configured such that the stepping motor 325 is drive and the drum 323 is rotated. That is, the tip storing section 34 is supplied (sent) with the pipette tip 3 contained in the tip supply mechanism section 32 from the sending part 30b through the sending part 30b. When the controller 2a determines that the pipette tip 3 is present on the inclined surface 362 of the movement member 361e (detection sensor 40b turned ON), the movement member 361 is moved upward.

In the present embodiment, the static eliminator fan 33 has a function of blowing ionized air, and can perform an eliminating operation of removing static electricity (electrification charge) of the pipette tip 3 stored in the tip storing section 34. The static eliminator fan 33 includes an ionizer 33a for generating ion, and a fan 33b for blocking air containing ion generated by the ionizer 33a. As shown in FIGS. 7 and 8, the static eliminator fan 33 is arranged on the upper side of the tip storing section 34 and the sending part 30b so as not to contact the pipette tip 3, and is arranged on a lid 331 configured to be openable/closable. The lid 331 is arranged in an openable/closable manner to enable maintenance of the interior of the tip storing section 34 and to enable cleaning work of the static eliminator fan when drawbacks such as clogging of the pipette tip 3 arise inside the tip storing section 34 etc. The lid 331 is configured to substantially close the space formed by the sending part 30b, the tip storing section 34, and the separating mechanism section 36. As shown in FIG. 8, the static eliminator fan 33 held by the lid 331 is arranged so that an air blow port 33a faces the vicinity of the separating mechanism section 36 side (region F of FIG. 8) of the receiving part 351. That is, the static eliminator fan 33 is arranged to blow ionized air to the pipette tip 3 positioned at the tip storing section 34, and blow ionized air to the pipette tip 3 positioned at the separating mechanism section 36. The static eliminator fan 33 is configured to be controlled by the controller 2a so that the drum 323 rotates, and the eliminating operation of the pipette tip 3 starts in synchronization with the sending of the pipette tip 3 contained in the tip supply mechanism section 32 (drum 323) from the sending part 30b to the tip storing section 34.

As shown in FIGS. 7 and 8, the discharge mechanism section 35 is configured so that the receiving part 351 turns from a first position H shown in FIG. 8 to a second position I (open position) shown in FIG. 8. As shown in FIG. 8, the discharge mechanism section 35 is configured by the receiving part 351 configuring one part of the tip storing section 34, the stepping motor 352 or the drive source for driving the receiving part 351, a belt 353 for transmitting the driving force of the stepping motor 352 to the receiving part 351, and an extension coil spring 354 for holding the receiving part 351 at the chassis 30a.

The receiving part 351 is rotatably attached with a rotating shaft 351a as a center with respect to the chassis 30a. The other side of the extension coil spring 354 which one side is connected to the chassis 30a is connected to the receiving part 351. The extension coil spring 354 is arranged to bias the receiving part 351 in the Al direction. The stepping motor 352 is attached to the chassis 30a. The belt 353 is configured so as to be moved in the A2 direction and the B2 direction by the stepping motor 352, where the receiving part 351 is rotated in the A1 direction with the rotating shaft 351a as the center when the belt 353 is moved in the A2 direction, and rotated in the B1 direction with the rotating shaft 351a as the center when the belt 353 is moved in the B2 direction.

The discharge mechanism section 35 is configured to rotate the receiving part 351 in the B1 direction before the drum 323 is rotated to send the pipette tip 3 from the containing part 323a of the drum 323 to the tip storing section 34. The pipette tip 3 remaining in the tip storing section 34 is discharged to a tip return port 355. As shown in FIGS. 10 and 11, the tip return port 355 is connected to the containing part 323a of the drum 323, and the pipette tip 3 discharged to the tip return port 355 is returned to the containing part 323a. That is, the discharge mechanism section 35 is configured so as to be controlled to return the pipette tip 3 remaining in the tip storing section 34 to the containing part 323a when flowing in a new pipette tip 3 from the containing part 323a of the drum 323 to the tip storing section 34.

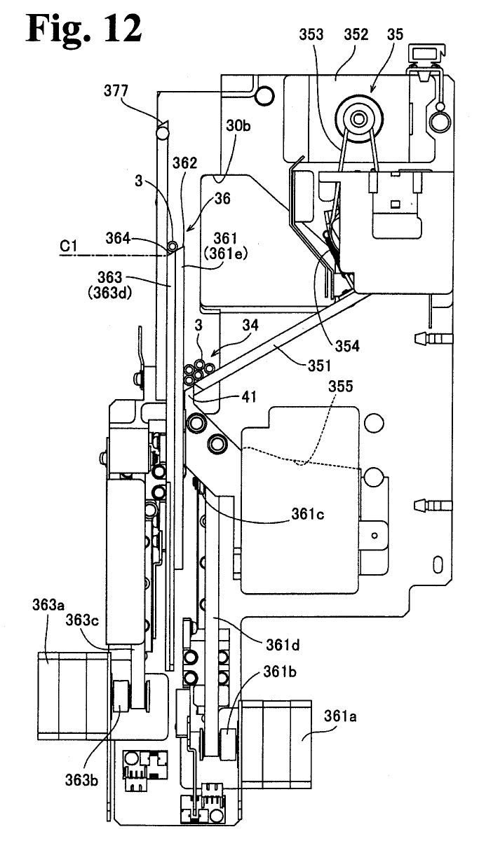

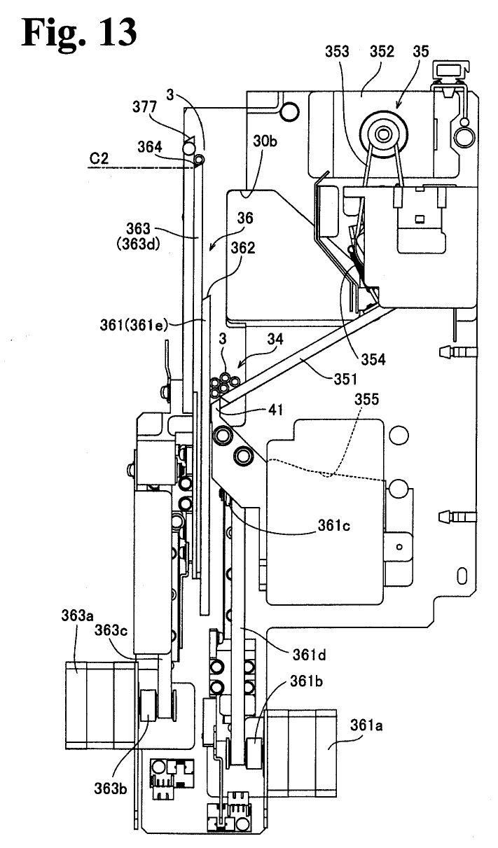

The separating mechanism section 36 is arranged to separate the pipette tips 3 received from the receiving part 351 through a relay member 41 one by one, and to send the pipette tip 3 separated one by one to the transfer section 37. As shown in FIGS. 12 and 13, the separating mechanism section 36 includes the cut-out mechanism part 361 for lifting the pipette tip 3 received from the receiving part 351 through the relay member 41 to the upper side, the inclined surface 362 for receiving the pipette tip 3 lifted by the cut-out mechanism part 361 and guiding the same to the cut-out mechanism part 363 to be hereinafter described, a cut-out mechanism part 363 for lifting two or less pipette tip 3 received from the inclined surface 362 to the upper side, and an inclined surface 364 for receiving the pipette tip 3 lifted by the cut-out mechanism part 363 and sending the same to the transfer section 37.

The cut-out mechanism part 361 is configured to separate one pipette tip 3 from the pipette tips 3 stored at least in plurals in the tip storing section 34. Specifically, as shown in FIG. 8, the cut-out mechanism part 361 is configured by a stepping motor 361a serving as a drive source, a pulley 361b connected to the stepping motor 361a, a pulley 361c arranged at a predetermined spacing from the pulley 361b, a drive transmission belt 361d attached to the pulley 361b and the pulley 361c, and a movement member 361e coupled to the drive transmission belt 361d and movable in an up and down direction (Z-direction). When the stepping motor 361a is driven, the drive transmission belt 361d is driven by way of the pulley 361b, and thus the movement member 361e coupled to the drive transmission belt 361d is moved in the up and down direction (Z-direction). As a result, the pipette tip 3 placed on the inclined surface 362 is moved from a state (state of FIG. 8) in which the movement member 361e is positioned at the lowermost point to a state (state of FIG. 12) in which the movement member 361e is positioned at the uppermost point, and is sent to the inclined surface 364 of a state in which the movement member 363d is positioned at the lowermost point (state of C1 position of FIG. 12).

The movement member 361e of the cut-out mechanism part 361 is configured to rise up to the vicinity (C1 position of FIG. 12) of the inclined surface 364 of the cut-out mechanism part 363, and then rise little by little (by one pitch) in a step-wise manner at a predetermined time (about 0.3 sec) interval. According to such configuration, the pipette tip 3 positioned on the upper side rolls to the inclined surface 364 first even if the movement member 361e is raised with two pipette tips 3 placed on the inclined surface 362 of the cut-out mechanism part 361, and thus two pipette tips 3 are suppressed from simultaneously rolling down the inclined surface 364.

The inclined surface 362 is formed by an inclined surface so that the pipette tip 3 rolls from the cut-out mechanism part 361 side towards the cut-out mechanism part 363 side.

The cut-out mechanism part 363 has a function of sending (moving) the received pipette tip 3 from the inclined surface 362 to the transfer section 37 one by one. Specifically, the cut-out mechanism part 363 is configured by a stepping motor 363a serving as a drive source, a pulley 363b connected to the stepping motor 363a, a pulley (not shown) arranged at a predetermined spacing from the pulley 363b, a drive transmission belt 363c attached to the pulley 363b and the pulley (not shown), and a movement member 363d coupled to the drive transmission belt 363d and movable in the up and down direction (Z-direction). When the stepping motor 363a is driven, the drive transmission belt 363c is driven by way of the pulley 363b, and thus the movement member 363d coupled to the drive transmission belt 363c is moved in the up and down direction (Z-direction). As a result, the pipette tip 3 placed on the inclined surface 364 of the movement member 363d can be lifted from C1 position of FIG. 12 to a C2 position of FIG. 13. In this case, the movement member 363d is formed to have a width such that only two or less pipette tip 3 can be placed on the inclined surface 364. The movement member 363d is configured such that even if moved upward (Z-direction) with two pipette tips 3 placed on the inclined surface 364 of the movement member 363d, one of the two pipette tips 3 loses balance from the upper surface of the movement member 363d and drop to the inclined surface 362 side. Thus, even if two pipette tips 3 are placed on the upper surface of the movement member 363d, the pipette tip 3 can be supplied to the transfer section 37 one by one.

The movement member 363d of the cut-out mechanism part 363 is configured to rise up to the vicinity (C2 position of FIG. 13) of the inclined surface 377 of the transfer section 37, and then rise little by little (by one pitch) in a step-wise manner at a predetermined time (about 0.3 sec) interval. According to such configuration, the pipette tip 3 positioned on the upper side rolls to the inclined surface 377 first even if the movement member 363d is raised with two pipette tips 3 placed on the inclined surface 364 of the cut-out mechanism part 363, and thus two pipette tips 3 are suppressed from simultaneously rolling down the inclined surface 377.

In the present embodiment, the separating mechanism section 36 and the static eliminator fan 33 are configured so that the eliminating operation is stopped during at least one part of the period of when the separating mechanism section 36 executes the separating operation by the controller 2a. Specifically, the static eliminator fan 33 is controlled by the controller 2a to suspend the blow of ionized air during a period from a time point at when the pipette tip 3 placed on the inclined surface 364 of the movement member 363d of the cut-out mechanism part 363 is moved to the vicinity (C2 position of FIG. 13) of the inclined surface 377 of the transfer section 37 to a time point at when the pipette tip 3 moved to the transfer section 37 is detected by the detection sensor 40d to be hereinafter described. Thus, the balance of the pipette tip 3 is suppressed from becoming unstable by the air blow of the static eliminator fan 33, and thus the pipette tip 3 is suppressed from being moved to the transfer section 37 in a balance different from the desired balance. When the detection sensor 40d to be hereinafter described detects the pipette tip 3, the static eliminator fan 33 is controlled by the controller 2a to resume air blow that has been suspended.

The inclined surface 364 is configured to an inclined surface so that the pipette tip 3 rolls from the cut-out mechanism part 363 side towards the inclined surface 377 side of the transfer section 37 to be hereinafter described, and has a function of supplying the pipette tip 3 to the transfer section 37.

The detection sensor (transmissive sensor) 40c (see FIG. 9) is attached to the cover member 34a (see FIG. 9), and is arranged to detect the presence or absence of the pipette tip 3 placed on the inclined surface 364 when the movement member 363d of the cut-out mechanism part 363 is moved to the lower side (to position of C1 of FIG. 12). When the pipette tip 3 is not detected by the detection sensor 40c (detection sensor 40c is turned OFF), the cut-out mechanism part 363 of the separating mechanism section 36 is prevented from operating. When the pipette tip 3 is detected by the detection sensor (transmissive sensor) 40c (detection sensor 40c is turned ON), the cut-out mechanism part 363 of the separating mechanism section 36 is configured such that the movement member 363d is moved to the upper side (to position of C2 of FIG. 13).

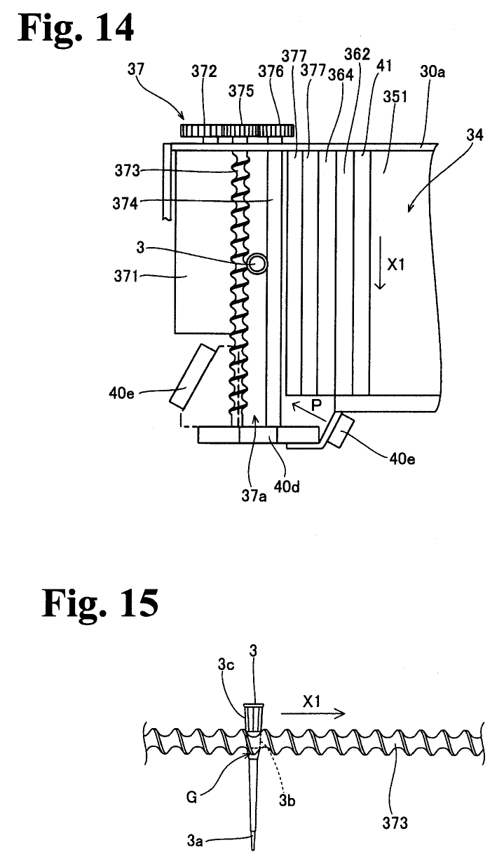

The transfer section 37 is arranged to move the pipette tip 3 separated one by one by the separating mechanism section 36, and rolled down from the inclined surface 364 of the separating mechanism section 36 in the direction of the arrow X1 (see FIG. 14). As shown in FIG. 14, the transfer section 37 is configured by a stepping motor 371 serving as a drive source, a pulley 372 attached to the shaft of the stepping motor 371, a feeding screw 373, a shaft 374, a pulley 375 attached to the feeding screw 373 and connected to the pulley 372 by way of a belt (not shown), a pulley 376 attached to the shaft 374 and connected to the pulley 375 by way of a belt (not shown), and an inclined surface 377 for receiving the pipette tip 3 rolled down from the inclined surface 364 and for rolling the same to the shaft 374. The feeding screw 373 is rotatably attached with respect to the chassis 30a. The feeding screw 373 and the shaft 374 are arranged so as to extend parallel to each other with an interval substantially the same as the diameter of a core part 3b (see FIG. 2) of the pipette tip 3. The feeding screw 373 and the shaft 374 then can hold the core part 3b of the pipette tip 3. In this case, as shown in FIG. 15, the core part 3b of the pipette tip 3 held by the feeding screw 373 and the shaft 374 is positioned on the upper side than a gravity point G (see FIG. 2) of the pipette tip 3, and thus is held by the feeding screw 373 and the shaft 374 with the distal end 3a of the pipette tip 3 rolled down from the inclined surface 364 of the separating mechanism section 36 arranged downward. On the direction of the arrow X1 of the feeding screw 373 and the shaft 374, an insertion part 37a having an interval larger than the diameter of an attachment part 3c of the pipette tip 3 is arranged when seen in plan view.

The detection sensor (transmissive sensor) 40d is arranged to detect whether or not the pipette tip 3 is held by the feeding screw 373 and the shaft 374. Specifically, the detection sensor 40d is arranged to emit light towards a direction (X direction) the feeding screw 373 extends, and is configured to detect whether or not the pipette tip 3 separated one by one by the separating mechanism section 36 is moved to the transfer section 37, and the detection sensor 40d is turned ON. Furthermore, the detection sensor (transmissive sensor) 40e is arranged to emit light towards a direction of an arrow P of FIG. 14, and is configured to detect whether or not the pipette tip 3 is positioned at a standby position near the insertion part 37a. That is, the detection sensor 40e is configured to detect whether or not the pipette tip 3 transported by the feeding screw 373 and the shaft 374 is sent to the standby position in front of the insertion part 37a, and the detection sensor 40e is turned ON.

As shown in FIG. 8, the chute 39a is arranged to guide the pipette tip 3 (see FIG. 2) dropped from the insertion part 37a (see FIG. 14) of the transfer section 37 to the transfer section 38.

The transfer section 38 is arranged to move the pipette tip 3 guided from the transfer section 37 through the chute 39a in the direction of the arrow Y1. The transfer section 38 is configured by a stepping motor 381 serving as a drive source (see FIG. 3), a pulley 382 attached to the stepping motor 381, a pulley 383 arranged at a predetermined interval with the pulley 382, a drive transmission belt 384 attached to the pulley 382 and the pulley 383, and a feeding screw 385 placed to be rotatable with the rotation of the pulley 383. The feeding screw 385 has a groove 285a of a diameter smaller than the diameter of the attachment part 3c (see FIG. 2) of the pipette tip 3 and larger than the diameter of the core part 3b (see FIG. 2) of the pipette tip 3. A wall part 386 is arranged in parallel with a predetermined interval with respect to the feeding screw 385 so that the pipette tip 3 fitted to the groove 385a of the feeding screw 385 does not drop. The feeding screw 385 and the wall part 386 then can hold the core part 3b of the pipette tip 3.

The detection sensor (transmissive sensor) 40f (see FIG. 9) is arranged near the lowermost portion of the chute 39a, and is arranged to detect whether or not the pipette tip 3 guided from the transfer section 37 through the chute 39a has reached the transfer section 38. The detection sensor 40f is configured to be turned ON when the pipette tip 3 is positioned at the transfer section 38 on the lower side of the chute 39a, and is configured to be turned OFF when the pipette tip 3 is moved in the direction of the arrow Y1 by the transfer section 38. The detection sensor (transmissive sensor) 40g (see FIG. 9) is arranged to detect whether or not the pipette tip 3 transported by the transfer section 38 is transported immediately in front of a position where pipette tip is dropped to the chute 39b to be hereinafter described.

The chute 39b is arranged to guide the pipette tip 3 transported by the transfer section 38 to the tip installing section 23b transport rack 23 of the urgent sample/tip transport section 20 described above. The chute 39b is formed so that the distal end 3a of the pipette tip 3 passing through slidably drops in an inclined state.

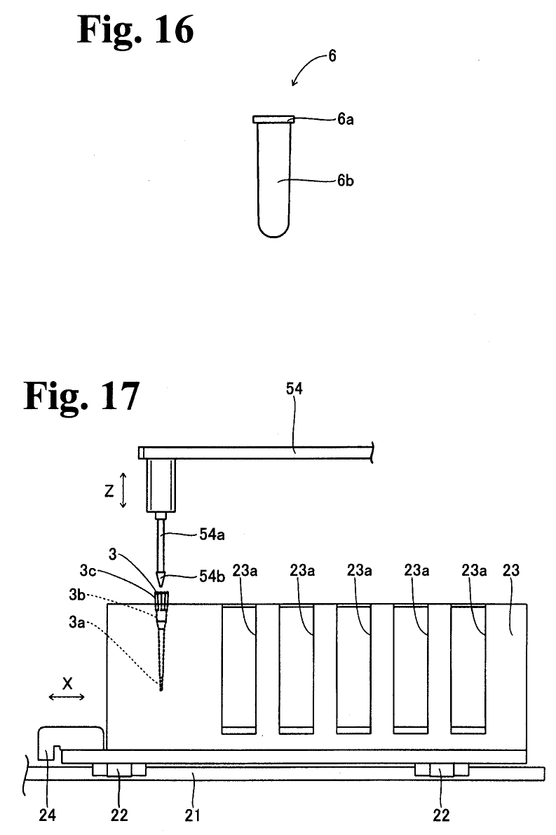

The sample dispensing arm 50 has a function of dispensing the sample in the test tube 4 transported to the aspirate position 1a (see FIG. 1) by the sample transport section 10 or the sample in the test tube 4 transported to the attachment position 1b (see FIG. 1) by the urgent sample/tip transport section 20 into a cuvette 6 (see FIG. 16) held by a holder 81b of a rotatable table 81a of the primary reaction member 81 to be hereinafter described. As shown in FIGS. 1 and 17, the sample dispensing arm 50 includes a motor 51, a drive transmitting part 52 connected to the motor 51, and an arm 54 attached to the drive transmitting part 52 by way of a shaft 53. The drive transmitting part 52 is configured to turn the arm 54 with the shaft 53 as the center by the driving force from the motor 51, and move the arm in the up and down direction (Z direction). A nozzle 54a for aspirating and discharging the sample is arranged at the distal end of the arm 54. The pipette tip 3 transported by a transport rack 23 of the urgent sample/tip transport section 20 is attached to the distal end 54b of the nozzle 54a.

The reagent installing member 61 (see FIG. 1) includes an installing section 61a for installing a reagent container 7 containing the R1 reagent including trapped antibody and a reagent container 9 containing the R3 reagent containing labeled antibody; an upper surface 61b arranged on the upper part of the installing section 61a so that foreign substances such as dust does not enter the R1 reagent in the reagent container 7 or the R3 reagent in the reagent container 9 installed in the installing section 61a; and a lid 61c attached in an openable/closable manner to the upper surface 61b. A groove 61d to be inserted with a nozzle 91e of the reagent dispensing arm 91, to be hereinafter described, and a groove 61e to be inserted with a nozzle 93e of the reagent dispensing arm 93 are formed in the upper surface 61b. The installing section 61a is rotatably configured to transport the installed reagent container 7 and the reagent container 9 to positions corresponding to the groove 61d and the groove 61e of the upper surface 61b, respectively.

The reagent installing member 62 (see FIG. 1) includes an installing section 62a for installing a reagent container 8 containing the R2 reagent containing magnetic particles; an upper surface 62b arranged on the upper part of the installing section 62a so that foreign substances such as dust does not enter the R2 reagent in the reagent container 8 installed in the installing section 62a; and a lid 62c attached in an openable/closable manner to the upper surface 62b. A groove 62d to be inserted with a nozzle 92e of the reagent dispensing arm 92, to be hereinafter described, is formed in the upper surface 62b. The installing section 62a is rotatably configured to transport the installed reagent container 8 to a position corresponding to the groove 62d of the upper surface 62b.

The cuvette supply member 70 (see FIG. 1) is configured so as to sequentially supply a plurality of cuvettes 6 (see FIG. 16) to the holder 81b of the rotatable table 81a of the primary reaction member 81. The cuvette supply member 70 includes a hopper feeder 71 capable of containing the plurality of cuvettes 6, two inductive plates 72 arranged on the lower side of the hopper feeder 71, a supporting board 73 arranged on the lower end of the inductive plate 72, and a supply catcher section 74. The two inductive plates 72 are arranged in parallel to each other with an interval smaller than the diameter of a collar 6a (see FIG. 16) of the cuvette 6 and larger than the diameter of a core part 6b (see FIG. 16) of the cuvette 6. The plurality of cuvettes 6 supplied to the hopper 71 are arrayed along the inductive plate 72 with the collar 6a engaged to the upper surface of the two inductive plates 72 by applying vibration to the hopper 71. The supporting board 73 includes a rotatable part 73a arranged rotatable with respect to the supporting board 73 and a concave part 73b arranged to be adjacent to the rotatable part 73a. Three cutouts 73c are formed every predetermined angle (120° in the present embodiment) at the outer peripheral portion of the rotatable part 73a. The cutout 73c is arranged to contain the cuvette 6 induced by the inductive plate 72 one by one. The concave part 73b is configured to receive the cuvette 6 which rotates while being contained in the cutout 73c of the rotatable part 73a.

The supply catcher section 74 (see FIG. 1) has a function of transporting the cuvette 6 received by the concave part 73b to the holder 81b of the rotatable table 81a of the primary reaction member 81. The supply catcher section 74 includes a motor 74a, a pulley 74b connected to the motor 74a, a pulley 74c arranged with a predetermined spacing from the pulley 74b, a drive transmission belt 74d attached to the pulley 74b and the pulley 74c, an arm 74e attached to the pulley 74c by way of a shaft, and a drive part 74f for moving the arm 74e in the up and down direction (Z direction). A chuck part 74g for sandwiching and gripping the cuvette 6 is arranged at the distal end of the arm 74e.

The primary reaction member 81 (see FIG. 1) is arranged to rotatably transport the cuvette 6 held at the holder 81b of the rotatable table 81a by a predetermined angle for every predetermined period (18 seconds in the present embodiment), and to stir the sample, the R1 reagent, and the R2 reagent in the cuvette 6. The primary reaction member 81 is configured by the rotatable table 81a for transporting the cuvette 6 containing the sample, the R1 reagent, and the R2 reagent in the rotating direction, and a transport mechanism section 81c for stirring the sample, the R1 reagent, and the R2 reagent in the cuvette 6 and transporting the cuvette 6 containing the stirred sample, the R1 reagent, and the R2 reagent to the BF separator 101 to be hereinafter described.

The reagent dispensing arm 91 (see FIG. 1) has a function of aspirating the R1 reagent in the reagent container 7 installed in the installing section 61a of the reagent installing member 61, and dispensing the aspirated R1 reagent into the cuvette 6 dispensed with the sample of the holder 81b of the rotatable table 81a of the primary reaction member 81. The reagent dispensing arm 91 includes a motor 91a, a drive transmitting part 91b connected to the motor 91a, and an arm 91d attached to the drive transmitting part 91b by way of a shaft 91c. The drive transmitting part 91b is configured to turn the arm 91d with the shaft 91c as the center by the driving force from the motor 91a, and move the arm in the up and down direction (Z-direction). A nozzle 91e for aspirating and discharging the R1 reagent in the reagent container 7 is attached to the distal end of the arm 91d. Thus, the nozzle 91e is configured to aspirate the R1 reagent in the reagent container 7 through the groove 61d of the upper surface 61b of the reagent installing member 61, and thereafter, dispense the aspirated R1 reagent into the cuvette 6 dispensed with the sample.

The reagent dispensing arm 92 (see FIG. 1) has a function of dispensing the R2 reagent in the reagent container 8 installed in the installing section 62a of the reagent installing member 62 into the cuvette 6 dispensed with the sample and the R1 reagent of the primary reaction member 81. The reagent dispensing arm 92 includes a motor 92a, a drive transmitting part 92b connected to the motor 92a, and an arm 92d attached to the drive transmitting part 92b by way of a shaft 92c. The drive transmitting part 92b is configured to turn the arm 92d with the shaft 92c as the center by the driving force from the motor 92a, and move the arm in the up and down direction (Z-direction). A nozzle 92e for aspirating and discharging the R2 reagent in the reagent container 8 is attached to the distal end of the arm 92d. Therefore, the nozzle 92e is configured to aspirate the R2 reagent in the reagent container 8 through the groove 62d of the upper surface 62b of the reagent installing member 62, and thereafter, dispense the aspirated R2 reagent into the cuvette 6 dispensed with the sample and the R1 reagent.

The BF (Bound Free) separator 101 (see FIG. 1) is arranged to remove the non-reactive R1 reagent in the cuvette 6 (see FIG. 16) received from the transport mechanism section 81c of the primary reaction member 81. The BF separator 101 includes an installing section 101a for installing the cuvette 6 and transporting the cuvette 6 in the rotating direction, and a separation stirring section 101b for aspirating the non-reactive R1 reagent. The installing section 101a includes three installing holes 101c for holding the cuvette 6, and a magnet 101d respectively arranged at the side of the three installing holes 101c. Thus, the bound antigen, the trapped antibody, and the magnetic particles in the cuvette 6 installed in the installing hole 101c can be attracted to the magnet 101d side. The sample etc. in the cuvette 6 is aspirated using the separation stirring section 101d in the attracted state to remove the non-reactive (free) R1 reagent not bound with the magnetic particle.

The transport catcher section 110 (see FIG. 1) has a function of transporting the cuvette 6 (see FIG. 16) of the installing section 101a of the BF separator 101 in which non-reactive R1 reagent etc. is separated to a holder 82b of a rotatable table 82a of the secondary reaction member 82. The transport catcher section 110 includes a motor 110a, a pulley 110b connected to the motor 110a, a pulley 110c arranged with a predetermined spacing from the pulley 110b, a drive transmission belt 110d attached to the pulley 110b and the pulley 110c, an arm 110e attached to the pulley 110c by way of a shaft, and a drive part 110f for moving the arm 110e in the up and down direction (Z-direction). A chuck part 110g for sandwiching and gripping the cuvette 6 is arranged at the distal end of the arm 110e.

The secondary reaction member 82 (FIG. 1) has a configuration similar to the primary reaction member 81, and is arranged to rotatably transport the cuvette 6 held at the holder 82b of the rotatable table 82a by a predetermined angle for every predetermined period (18 seconds in the present embodiment), and to stir the sample, the R1 reagent, the R2 reagent, the R3 reagent, and the R5 reagent in the cuvette 6. The secondary reaction member 82 is configured by the rotatable table 82a for transporting the cuvette 6 containing the sample, the R1 reagent, the R2 reagent, the R3 reagent and the R5 reagent in the rotating direction, and a transport mechanism section 82c for stirring the sample, the R1 reagent, the R2 reagent, the R3 reagent and the R5 reagent in the cuvette 6 and transporting the cuvette 6 containing the stirred sample etc. to the BF separator 102 to be hereinafter described. The transport mechanism section 82c has a function of again transporting the cuvette 6 processed by the BF separator 102 to the holder 82b of the rotatable table 82a.

The reagent dispensing arm 93 (see FIG. 1) has a function of aspirating the R3 reagent in the reagent container 9 installed at the installing section 61a of the reagent installing member 61 and dispensing the aspirated R3 reagent into the cuvette 6 dispensed with the sample, the R1 reagent, and the R2 reagent of the secondary reaction member 82. The reagent dispensing arm 93 includes a motor 93a, a drive transmitting part 93b connected to the motor 93a, and an arm 93d attached to the drive transmitting part 93b by way of a shaft 93c. The drive transmitting part 93b is configured to turn the arm 93d with the shaft 93c as the center by the driving force from the motor 93a, and move the arm in the up and down direction (Z-direction). A nozzle 93e for aspirating and discharging the R3 reagent in the reagent container 9 is attached to the distal end of the arm 93d. Thus, the nozzle 93e aspirates the R3 reagent in the reagent container 9 through the groove 61e of the upper surface 61b of the reagent installing member 61, and thereafter, dispenses the aspirated R3 reagent into the cuvette 6 dispensed with the sample, the R1 reagent, and the R2 reagent.

The BF separator 102 (see FIG. 1) has a configuration similar to the BF separator 101, and is arranged to remove the non-reactive R3 reagent in the cuvette 6 (see FIG. 16) received by the transport mechanism section 82c of the secondary reaction member 82. The BF separator 102 includes an installing section 102a for installing the cuvette 6 and transporting the cuvette 6 in the rotating direction, and a separation stirring section 102b for aspirating the non-reactive R3 reagent. The installing section 102a includes three installing holes 102c for holding the cuvette 6, and a magnet 102d respectively arranged at the side of the three installing holes 102c. Thus, the bound magnetic particles, the antigen, and the labeled antibody in the cuvette 6 installed in the installing hole 102c can be attracted to the magnet 102d side. The sample etc. in the cuvette 6 is aspirated using the separation stirring section 102d in the attracted state to remove the non-reactive (free) R3 reagent.

The reagent dispensing arm 94 (see FIG. 1) has a function of dispensing the R5 reagent containing luminescent substrate in the reagent container (not shown) installed at the lower part of the immune analyzer 1 into the cuvette 6 containing the sample, the R1 reagent, and the R2 reagent, and the R3 reagent of the secondary reaction member 82. The reagent dispensing arm 94 includes a motor 94a, a drive transmitting part 94b connected to the motor 94a, and an arm 94c attached to the drive transmitting part 94b by way of a shaft. The drive transmitting part 94b is configured to turn the arm 94c with the shaft as the center by the driving force from the motor 94a, and move the arm in the up and down direction (Z-direction). A nozzle (not shown) for aspirating and discharging the R5 reagent is attached to the distal end of the arm 94c.

The detector 120 (see FIG. 1) is arranged to measure the amount of antigen contained in a sample by acquiring the light generated in the reaction process of the labeled antibody bound to the antigen of the sample performed with a predetermined process and the luminescent substrate with a photo multiplier tube. The detector 120 is configured by an installing section 121 for installing the cuvette 6 containing the sample, the R1 reagent, the R2 reagent, the R3 reagent, and the R5 reagent, and a transport mechanism section 122 for transporting the cuvette 6 (see FIG. 16) held at the holder 82b of the rotatable table 82a of the secondary reaction member 82.

The waste member 130 (see FIG. 1) is arranged to discard the measured sample measured by the detector 120 and the cuvette 6 (see FIG. 16) containing the relevant sample. The waste member 130 is configured by an aspiration part 131 for aspirating the sample and various reagents in the cuvette 6 and a discarding hole 132 arranged at a position of a predetermined spacing from the aspiration part 131. After the measured sample etc. is aspirated by the aspiration part 131, the used cuvette 6 is discarded to a dust box (not shown) arranged at the lower part of the immune analyzer 1 through the discarding hole 132.

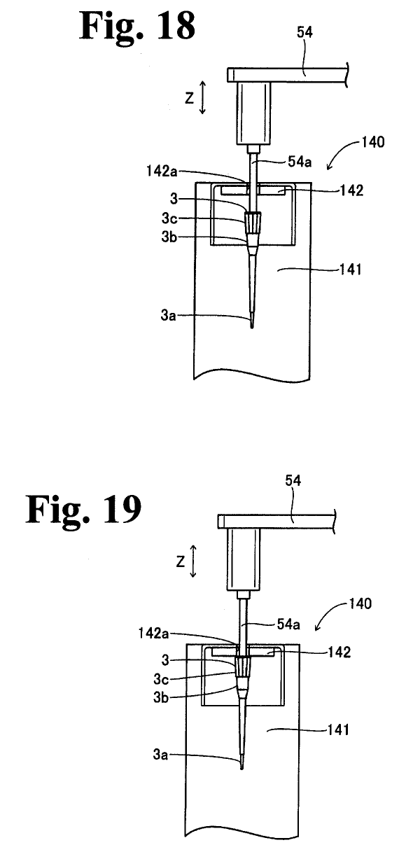

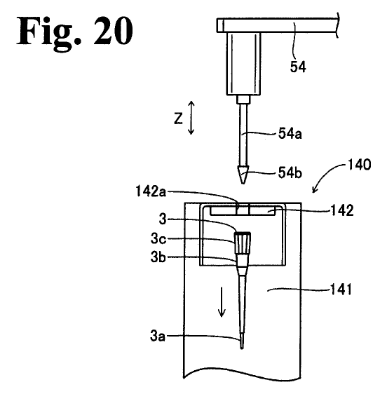

The tip detachment member 40 (see FIG. 1) is provided to detach the pipette tip 3 attached to the sample dispensing arm 50. As shown in FIG. 18, the tip detachment member 140 includes a steel plate 141 arranged to extend in a vertical direction (Z-direction), and a release piece 142 made of resin attached to the steep plate 141. The release piece 142 is formed with a cutout 142a having a diameter smaller than the diameter of the attachment part 3c (see FIG. 20) of the pipette tip 3, and larger than the diameter of the distal end 54b (see FIG. 20) of the arm 54 of the sample dispensing arm 50.

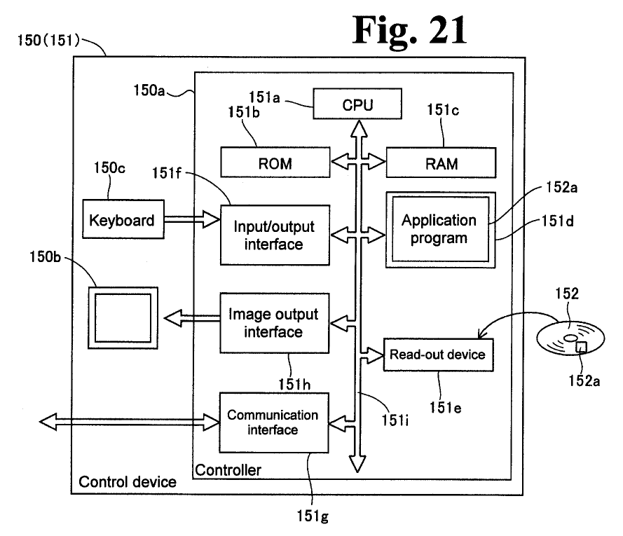

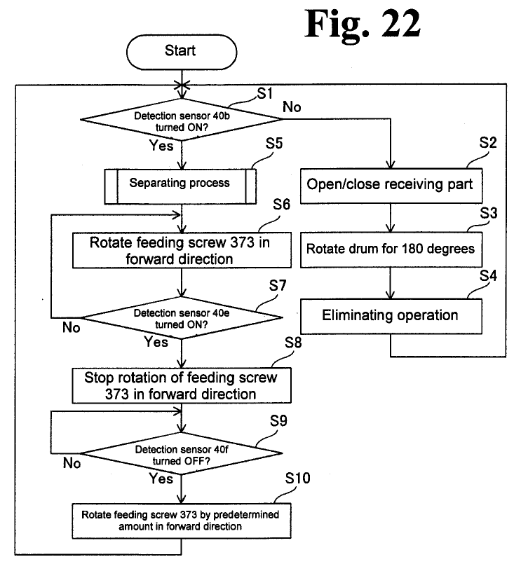

The data processing unit 150 (see FIG. 1) is configured by a personal computer (PC), and includes a controller 150a (see FIG. 21) consisting of CPU, ROM, RAM, and the like, a display member 150b (see FIGS. 1 and 21), and a keyboard 150c (see FIGS. 1 and 21). The display member 150a is provided to display the analysis result obtained by analyzing data of the digital signal transmitted from the measurement unit 2.

The configuration of the control device 150 will now be described. As shown in FIG. 21, the data processing unit 150 is configured by a computer 151 mainly configured by the controller 150a, the display member 150b, and the keyboard 150c. The controller 150a is mainly configured by a CPU 151a, a ROM 151b, a RAM 151c, a hard disc 151d, a read-out device 151e, an input/output interface 151f, a communication interface 151g, and an image output interface 151h. The CPU 151a, the ROM 151b, the RAM 151c, the hard disc 151d, the read-out device 151e, the input/output interface 151f, the communication interface 151g, and the image output interface 151h are connected by a bus 151i.

The CPU 151a executes computer programs stored in the ROM 151b and the computer programs loaded in the RAM 151c. The computer 151 serves as the data processing unit 150 when the CPU 151a executes the application program 152a, as hereinafter described.

The ROM 151b is configured by mask ROM, PROM, EPROM, EEPROM, and the like, and is recorded with computer programs to be executed by the CPU 151a, data used for the same, and the like.

The RAM 151c is configured by SRAM, DRAM, and the like. The RAM 151c is used to read out the computer programs recorded on the ROM 151b and the hard disc 151d. The RAM 151c is used as a work region of the CPU 151a when executing the computer programs.

The hard disc 151d is installed with various computer programs to be executed by the CPU 151a such as operating system and application program, as well as data used in executing the computer program. The application program 152a for immune analysis according to the present embodiment is also installed in the hard disc 151d.

The read-out device 151e is configured by flexible disc drive, CD-ROM drive, DVD-ROM drive, and the like, and is able to read out computer programs and data recorded on a portable recording medium 152. The application program 152a for immune analysis is stored in the portable recording medium 152, where the computer 151 reads out the application program 152a from the portable recording medium 152, and installs the application program 152a to the hard disc 151d.

The application program 152a is not only provided by the portable recording medium 152, but is also provided through communication line (wired or wireless) from external devices communicatably connected with the computer 151 through the communication line. For instance, the application program 152a may be stored in the hard disc of the server computer on the Internet, so that the computer 151 can access the server computer 151 to download the application program 152a and install the application program 152a to the hard disc 151d.

Operating system providing graphical user interface environment such as Windows (registered trademark) manufactured and sold by US Microsoft Co. is installed in the hard disc 151d. In the following description, the application program 152a according to the present embodiment is assumed to operate on the operating system.

The input/output interface 401f is configured by serial interface such as USB, IEEE1394, RS-232C; parallel interface such as SCSI, IDE, IEEE1284; analog interface such as D/A converter, A/D converter, and the like. The keyboard 150c is connected to the input/output interface 151f, so that the user can input data to the computer 151 using the keyboard 150c.

The communication interface 151g is, for example, Ethernet (registered trademark) interface. The computer 151 transmits and receives data with the measurement unit 2 using a predetermined communication protocol by means of the communication interface 151g.

The image output interface 151h is connected to the display member 150b configured by LCD, CRT, or the like, and is configured to output an image signal corresponding to the image data provided from the CPU 151a to the display member 150b. The display member 150b displays the image (screen) according to the input image signal. The display member 150b is configured to display buttons for making various instructions to the apparatus, where the apparatus performs the process corresponding to the button when the button is selected. In the display member 150b, the user can perform operations such as instruction to start or stop the measurement with respect to the apparatus, setting of the apparatus, and instruction to replace or take out reagent. The display member 150b is configured by a touch panel, so that the user can select the button by directly touching the button displayed on the display member 150b. The button can be selected by a pointer movable by a mouse etc. (not shown).

The immune analysis application program 152a installed in the hard disc 151d of the controller 150a measures the amount of antigen or antibody in the measurement specimen using the light emission amount (data of digital signal) of the measurement specimen transmitted from the measurement unit 2.

The supply operation of supplying the pipette tip stored in the tip storing section of the pipette tip supplier to the transfer section will be described with reference to FIGS. 3, 8 to 10, 14, and 22.

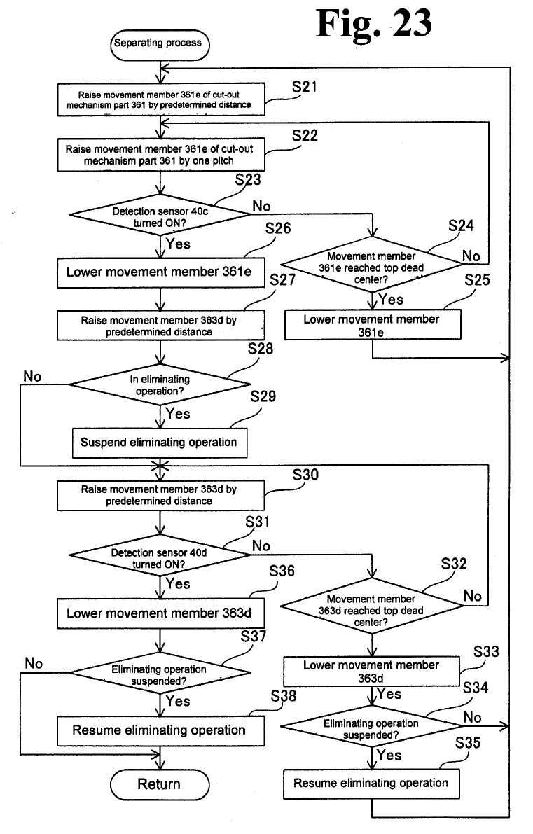

First, as shown in FIG. 22, whether or not the detection sensor 40b (see FIG. 9) is turned ON is determined by the controller 2a (see FIG. 3) in step S1. Specifically, as shown in FIG. 8, whether or not the pipette tip 3 stored in the tip storing section 34 is placed on the inclined surface 362 of the cut-out mechanism part 361 is determined. As shown in FIG. 22, if determined that the detection sensor 40b (see FIG. 9) is turned ON in step S1, the controller 2a determines that the pipette tip 3 is not stored in the tip storing section 34, and the process proceeds to step S2, the receiving part 351 is opened/closed between the position of I and the position of H in step S2, and the process proceeds to step S3. Thereafter, in step S3, the drum 323 (see FIG. 10) of the tip supply mechanism section 32 is rotated 180 degrees, the eliminating operation of the static eliminator fan 33 is started at the same time as the rotating operation of the drum 323 of the tip supply mechanism section 32 in step S4, and the process returns to step S1. If determined that the detection sensor 40b is turned ON in step S1, the process proceeds to step S5, the separating process of the pipette tip 3 is carried out in step S5, the pipette tip 3 separated one by one is held between the feeding screw 373 and the shaft 374 of the transfer section 37, and then the process proceeds to step S6. The details of the separating process of the pipette tip 3 carried out in step S5 will be hereinafter described.

Subsequently, in step S6, the feeding screw 373 is rotated in the forward direction, the pipette tip 3 is moved in the direction of the arrow X1 (see FIG. 14), and the process proceeds to step S7. In step S7, whether or not the detection sensor 40e (see FIG. 9) is turned ON is determined by the controller 2a. Specifically, whether or not the pipette tip 3 held between the feeding screw 373 (see FIG. 14) and the shaft 374 (see FIG. 14) is positioned near the insertion part 37a (see FIG. 14) is determined. If determined that the detection sensor 40e is not turned ON in step S7, the process returns to step S6, and the operations of step S6 and step S7 are repeated until the detection sensor 40e is turned ON. If determined that the detection sensor 40e is not turned ON in step S7, the process proceeds to step S8.

Thereafter, in step S8, the rotation of the feeding screw 373 of the transfer section 37 is stopped by the controller 2a, and the process proceeds to step S9. Whether or not the detection sensor 40f (see FIG. 9) is not turned ON (turned OFF) is determined in step S9. Specifically, whether or not the pipette tip 3 is positioned at the portion on the lower side of the chute 39a (see FIG. 8) of the transfer section 38 is determined. Accordingly, whether or not to insert the pipette tip 3 near the insertion part 37a of the transfer section 37 to the chute 39a can be determined. If determined that the detection sensor 40f is turned ON in step S9, the pipette tip 3 is positioned at the portion on the lower side of the chute 39a, and thus insertion of the pipette tip held at the transfer section 37 to the chute 39a needs to be waited until the pipette tip 3 no longer exists at the relevant position. Thus, determination of step S9 is repeated until the detection sensor 40f is turned OFF. If determined that the detection sensor 40f is turned OFF in step S9, the pipette tip 3 is not positioned at the portion on the lower side of the chute 39a, the process proceeds to step S10, the feeding screw 373 of the transfer section 37 is rotated by a predetermined amount in the positive direction, and the pipette tip held at the transfer section 37 is inserted to the chute 39a. Thereafter, the process returns to step S1. The operation of supplying the pipette tip 3 stored in the tip storing section 34 of the pipette tip supplier 30 to the transfer section 38 is thereby terminated.

The details of the separating process of the pipette tip 3 in the pipette tip supplier 30 will be described with reference to FIGS. 3, 8, 9, 12 to 14, and 23.

As shown in FIGS. 8 and 23, in step S21, the movement member 361e is raised to a predetermined position (near position C1 of FIG. 12) as shown in FIG. 9 with the pipette tip 3 placed on the inclined surface 362 of the movement member 361e of the cut-out mechanism part 361, and the process proceeds to step S22. In step S22, the movement member 361e of the cut-out mechanism part 361 is raised by one pitch from the predetermined position, and the process proceeds to step S23.

Thereafter, in step S23, whether or not the detection sensor 40c (see FIG. 9) is turned ON is determined by the controller 2a (see FIG. 3). Specifically, whether or not the pipette tip 3 placed on the inclined surface 362 of the movement member 361e is moved to the inclined surface 364 of the movement member 363d is determined. If determined that the detection sensor 40c is not turned ON in step S23, the process proceeds to step S24, and whether or not the movement member 361e has reached the position at the uppermost point is determined in step S24. If determined that the movement member 361e has not reached the position at the uppermost point in step S24, the process returns to step S22. If determined that the movement member 361e has reached the position at the uppermost point in step S24, the movement member 361e is lowered in step S25, and the process returns to step S21. If determined that the detection sensor 40c is turned ON in step S23, the process proceeds to step S26. That is, the pipette tip 3 placed on the inclined surface 362 of the movement member 361e rolls on the inclined surface 362 when passing the position C1 of FIG. 12, and moves to the inclined surface 364 of the movement member 363d. If the pipette tip 3 placed on the inclined surface 362 of the movement member 361e drops from the inclined surface 362 before reaching the position C1 of FIG. 12, the pipette tip 3 does not move onto the inclined surface 364 of the movement member 363d even when the inclined surface 362 passes the position C1 of FIG. 12, and the detection sensor 40c remains turned OFF. Therefore, if the movement member 361e reaches the position at the uppermost point while the detection sensor 40c is turned OFF, pipette tip 3 is determined to have dropped from the inclined surface 362, and thus the separating process is executed again from the beginning.

In step S26, the movement member 361e is lowered, the process proceeds to step S27, and in step S27, the movement member 363d is raised to a predetermined position (near position C2) as shown in FIG. 13 with the pipette tip 3 placed on the inclined surface 364 (see FIG. 8) of the movement member 363d (see FIG. 8) of the cut-out mechanism part 363 (see FIG. 8) (state of FIG. 12).

Thereafter, in step S28, whether or not the static eliminator fan 33 (see FIG. 8) is in the eliminating operation is determined by the controller 2a. In the present embodiment, if determined that the static eliminator fan 33 is in the eliminating operation in step S28, the process proceeds to step S29, the eliminating operation of the static eliminator fan 33 is suspended, and the process proceeds to step S30. If determined that the static eliminator fan 33 is not in the eliminating operation in step S28, the process proceeds to step S30. In step S30, the movement member 363d of the cut-out mechanism part 363 is raised by one pitch from the predetermined position (near position C2), and the process proceeds to step S31.

Thereafter, in step S31, whether or not the detection sensor 40d (see FIG. 9) is turned ON is determined by the controller 2a. Specifically, whether or not the pipette tip 3 placed on the inclined surface 364 of the movement member 363d is held between the feeding screw 373 (see FIG. 14) and the shaft 374 (see FIG. 14) of the transfer section 37 through the inclined surface 377 is determined. If determined that the detection sensor 40d is not turned ON in step S31, the process proceeds to step S32, and whether or not the movement member 363d has reached the position at the uppermost point is determined in step S32. If determined that the movement member 363d has not reached the position at the uppermost point in step S32, the process returns to step S30. If determined that the movement member 363d has reached the position at the uppermost point in step S32, the process proceeds to step S33, and the movement member 363d is lowered to the position C1 of FIG. 12. Thereafter, whether or not the eliminating operation of the static eliminator fan 33 is suspended is determined by the controller 2a in step S34. If determined that the eliminating operation is suspended in step S34, the process proceeds to step S35, the eliminating operation of the static eliminator fan 33 is resumed in step S35, and the process returns to step S21. If determined that the eliminating operation is not suspended in step S34, the process returns to step S21. If determined that the detection sensor 40d is turned ON in step S31, the process proceeds to step S36. That is, the pipette tip 3 placed on the inclined surface 364 of the movement member 363d rolls on the inclined surface 364 and the inclined surface 377 when going over the inclined surface 377, and is held between the feeding screw 373 (see FIG. 14) and the shaft 374 (see FIG. 14) of the transfer section 37. If the pipette tip 3 placed on the inclined surface 364 of the movement member 363d drops from the inclined surface 364 before reaching the height of the inclined surface 377, the pipette tip 3 is not held between the feeding screw 373 and the shaft 374 of the transfer section 37 even when the inclined surface 364 goes over the height of the inclined surface 377, and the detection sensor 40d remains turned OFF. Therefore, if the movement member 363d reaches the position at the uppermost point while the detection sensor 40d is turned OFF, pipette tip 3 is determined to have dropped from the inclined surface 364, and thus the separating process is executed again from the beginning.

In step S36, the movement member 363d is lowered to the position C1 of FIG. 12. Whether or not the eliminating operation of the static eliminator fan 33 is suspended is determined by the controller 2a in step S37. If determined that the eliminating operation is suspended in step S37, the process proceeds to step S38, the eliminating operation of the static eliminator fan 33 is resumed in step S38, and the process returns. If determined the eliminating operation is not suspended in step S37, the process returns.

The detachment operation of the pipette tip attached to the sample dispensing arm will be described below with reference to FIGS. 18 to 20.

First, as shown in FIG. 18, the arm 54 attached with the used pipette tip 3 is moved downward, and the arm 54 is rotated so that the nozzle 54a of the arm 54 fits into the cutout 142a of the release piece 142 of the tip detachment member 140. From this state, the arm 54 is moved upward as shown in FIG. 19, thereby contacting the lower surface of the release piece 142 of the tip detachment member 140 and the upper surface of the attachment part 3c of the pipette tip 3. Subsequently, as shown in FIG. 20, the arm 54 is moved upward, and the pipette tip 3 is detached from the distal end 54b of the nozzle 54a of the arm 54.

In the present embodiment, the electrification charges on the pipette tip 3 can be removed with the pipette tip 3 in a stationary state by arranging the static eliminator fan 33 for performing the eliminating operation of removing the electrification charge from the pipette tip 3 stored in the tip storing section 34 as described above, and thus the period of removing the electrification charge of the pipette tip 3 can be sufficiently ensured. The electrification charge on the pipette tip 3 thus can be sufficiently removed, and the pipette tips 3 are suppressed from being attracted to each other. As a result, the pipette tip 3 can be smoothly supplied. The separating operation of the separating mechanism section 36 is suppressed from being inhibited by the operation of the static eliminator fan 33 by arranging the controller 2a for controlling the static eliminator fan 33 and the separating mechanism section 36 so as to stop the eliminating operation of the static eliminator fan 33 in at least one part of the period of when the separating mechanism section 36 executes the separating operation. The pipette tip 3 is thereby smoothly supplied.

In the present embodiment, the orientation of the pipette tip 3 is suppressed from becoming unstable due to the blow of ionized air by the static eliminator fan 33 when the pipette tip 3 is moved from the separating mechanism section 36 to the transfer section 37 by controlling the static eliminator fan 33 so as to suspend the blow of ionized air when the pipette tip 3 separated by the separating mechanism section 36 is moved to the vicinity of the transfer section 37, as described above.

In the present embodiment, the orientation of the pipette tip 3 is suppressed from becoming unstable by the operation of the static eliminator fan 33 when the pipette tip 3 is moved from the inclined surface 364 of the movement member 363d of the cut-out mechanism part 363 to the transfer section 37 by controlling the static eliminator fan 33 so as to suspend the eliminating operation during a period from the time point the inclined surface 364 of the movement member 363d of the cut-out mechanism part 363 receiving the pipette tip 3 is moved to the predetermined position (position C1 of FIG. 12) in the vicinity of the transfer section 37 to the time point the pipette tip 3 is moved to the transfer section 37 side, as described above.

In the present embodiment, since the pipette tip 3 is resupplied to the tip storing section 34 immediately after the pipette tip 3 is no longer stored in the tip storing section 34 by controlling the drum 323 so that the pipette tip 3 contained in the tip supply mechanism section 32 is sent to the tip storing section 34 when the detection sensor 40b does not detect the pipette tip 3 as described above, the pipette tip 3 can be smoothly supplied to the transfer sections 37 and 38 without stopping the supply of the pipette tip 3.

The embodiment disclosed herein is merely illustrative in all aspects and should not be recognized as being restrictive. The scope of the invention is defined by the scope of the claims rather than by the description of the embodiment, and meaning equivalent to the claims and all modifications within the scope is encompassed herein.

For instance, in the present embodiment, a case of applying the pipette tip supplier for supplying disposable pipette tips one by one to the immune analyzer has been shown, but the present invention is not limited thereto, and as long as it is the apparatus using disposable pipette tips, the pipette tip supplier can be applied to apparatuses other than the immune analyzer such as gene amplification measurement apparatus, blood coagulation measurement apparatus, and multiple blood cell analyzer.

In the embodiment described above, a case of controlling so as to turn ON the drive of the static eliminator fan in synchronization with the execution of the rotating operation of the drum has been shown, but the present invention is not limited thereto, and the static eliminator fan may be constantly driven while the pipette tip supplier is being driven irrespective of the rotating operation of the drum other than the period of suspending the eliminating operation of the static eliminator fan.

In the embodiment described above, a case of inserting a plurality of pipette tips to the drum through the discharge port from the tip resupplying section after containing the plurality of resupplying pipette tips to the tip resupplying section has been shown, but the present invention is not limited thereto, and the plurality of pipette tips may be directly inserted to the drum.

In the above described embodiment, a case of lifting the pipette tip stored at the lower part of the drum and sending the same to the tip storing section by the segmenting part of the drum by rotating the drum has been described, but the present invention is not limited thereto, and a predetermined amount of pipette tips can be sent to the transport path by the transport belt from the location containing the pipette tip, or the pipette tip may be sent to the transport path by lifting the pipette tip as in the cut-out mechanism part of the separating mechanism section of the present embodiment. The ionized air of the static eliminator fan may be blown to the location containing the pipette tip, if an environment is such that pipette tips are not charged with electrification charges even when the pipette tips rub against each other.

In the above described embodiment, a case of removing electrification charges of the pipette tip by blowing ionized air from the static eliminator fan has been described, but the present invention is not limited thereto, and the electrification charges of the pipette tip may be removed by contacting the conductive member to the pipette tip. For instance, the electrification charges of the pipette tip may be removed by contacting a brush consisting of fiber having conductivity such as carbon fiber and stainless fiber.

It should be apparent to those skilled in the art that the present invention may be embodied in many other specific forms without departing from the spirit or scope of the invention. Therefore, the present invention is not to be limited to the details given herein, but may be modified within the scope and equivalence of the appended claims.

What is claimed is:

1. A pipette tip supplier, comprising:
a containing section for containing pipette tips for aspirating samples;
a storing section for storing pipette tips supplied from the containing section;
a static eliminator for performing an eliminating operation for eliminating electrification charge of the pipette tips being stored by the storing section; and
a separator for performing a separating operation for separating the pipette tips being stored by the storing section one by one.

2. The pipette tip supplier of claim 1, wherein the static eliminator eliminates the electrification charge of the pipette tips being stored by the storing section and the pipette tips being separated by the separator.

3. The pipette tip supplier of claim 1, further comprising a controller for controlling the static eliminator,
wherein the controller controls the static eliminator so as to suspend the eliminating operation for a period while the separator is executing the separating operation.

4. The pipette tip supplier of claim 3, wherein the static eliminator comprises an ionizer for generating ion, and a fan for eliminating the electrification charge of the pipette tips being stored by the storing section by blowing air containing the ion generated by the ionizer.

5. The pipette tip supplier of claim 4, wherein the fan blows the air containing the ion to the pipette tips being stored by the storing section and the pipette tips being separated by the separator.

6. The pipette tip supplier of claim 4, further comprising a transport section for transporting the pipette tips separated one by one by the separator,
wherein the controller controls the static eliminator so as to suspend a blow of the air containing the ion when the pipette tips separated by the separator are moved to the transport section.

7. The pipette tip supplier of claim 6, wherein
the separator comprises a first separating plate configured to separate at least one pipette tip from the pipette tips being stored by the storing section, and a second separating plate configured to receive the pipette tip separated by the first separating plate and to move the received pipette tip to the transport section; and
the controller controls the static eliminator so as to suspend the blow of the air containing the ion during a period from a time point the second separating plate receiving the pipette tip is moved to a predetermined position near the transport section to a time point the pipette tip received by the second separating plate is moved to the transport section side.

8. The pipette tip supplier of claim 7, further comprising a sensor for detecting a pipette tip moved to the transport section,
wherein the controller controls the static eliminator so as to resume the suspended eliminating operation when the sensor detects the pipette tip.

9. The pipette tip supplier of claim 3, wherein the controller controls the static eliminator so as to start the eliminating operation when the pipette tip contained in the containing section is supplied to the storing section.

10. The pipette tip supplier of claim 1, further comprising
a sensor for detecting a pipette tip being stored by the storing section; and
a supply controller for controlling the containing section so as to supply pipette tips contained in the containing section to the storing section when the sensor does not detect the pipette tip.

11. The pipette tip supplier of claim 1, wherein
the containing section comprises a sending port for sending the contained pipette tips to the storing section;
the storing section is arranged at a lower side of the sending port;
the separator is arranged adjacent to the storing section; and
the static eliminator is arranged at an upper side of the sending port, and comprises: a lid for substantially closing a space formed by the sending port, the storing section and the separator; an ionizer for generating ion; and a fan for blowing air containing the ion generated by the ionizer to the sending port, the storing section and the separator.

12. A sample analyzer, comprising:
a containing section for containing pipette tips for aspirating samples;
a storing section for storing pipette tips supplied from the containing section;
a static eliminator for performing an eliminating operation for eliminating electrification charge of the pipette tips being stored by the storing section;
a separator for performing a separating operation for separating the pipette tips being stored by the storing section one by one;
a dispenser comprising an aspirating nozzle to which the pipette tip separated by the separator is attachable, and for dispensing a sample with the pipette tip attached to the aspirating nozzle; and
an analyzing section for analyzing the sample dispensed by the dispenser.

13. The sample analyzer of claim 12, further comprising a controller for controlling the static eliminator so as to suspend the eliminating operation for a period while the separator is executing the separating operation.

14. A pipette tip supplier, comprising:
a containing section for containing pipette tips for aspirating samples, and comprising a sending port for sending the contained pipette tips;
a storing section being arranged at a lower side of the sending port, and for storing the pipette tips sent from the containing section through the sending port;
a separator being arranged adjacent to the storing section, and for performing a separating operation for separating the pipette tips being stored by the storing section one by one; and
a static eliminator being arranged at an upper side of the sending port, and comprising: a lid for substantially closing a space formed by the sending port, the storing section and the separator; an ionizer for generating ion; and a fan for blowing air containing the ion generated by the ionizer to the sending port, the storing section and the separator.

15. The pipette tip supplier of claim 14, further comprising a controller for controlling the static eliminator,
wherein the controller controls the static eliminator so as to suspend a blow of the air containing the ion for a period while the separator is executing the separating operation.

16. The pipette tip supplier of claim 15, further comprising a transport section for transporting the pipette tips separated one by one by the separator,
wherein the controller controls the static eliminator so as to suspend the blow of the air containing the ion when the pipette tips separated by the separator are moved to the transport section.

17. The pipette tip supplier of claim 16, wherein
the separator comprises a first separating plate configured to separate at least one pipette tip from the pipette tips being stored by the storing section, and a second separating plate configured to receive the pipette tip separated by the first separating plate and to move the received pipette tip to the transport section; and
the controller controls the static eliminator so as to suspend the blow of the air containing the ion during a period from a time point the second separating plate receiving the pipette tip is moved to a predetermined position near the transport section to a time point the pipette tip received by the second separating plate is moved to the transport section side.

18. The pipette tip supplier of claim 17, further comprising a sensor for detecting a pipette tip moved to the transport section,
wherein the controller controls the static eliminator so as to resume the blow of the air containing the ion when the sensor detects the pipette tip.

19. The pipette tip supplier of claim 15, wherein the controller controls the static eliminator so as to start the blow of the air containing the ion when the pipette tip contained in the containing section is sent to the storing section through the sending port.

20. A sample analyzer, comprising:
a containing section for containing pipette tips for aspirating samples, and comprising a sending port for sending the contained pipette tips;
a storing section being arranged at a lower side of the sending port, and for storing the pipette tips sent from the containing section through the sending port;
a separator being arranged adjacent to the storing section, and for performing a separating operation for separating the pipette tips being stored by the storing section one by one; and
a static eliminator being arranged at an upper side of the sending port, and comprising: a lid for substantially closing a space formed by the sending port, the storing section and the separator; an ionizer for generating ion; and a fan for blowing air containing the ion generated by the ionizer to the sending port, the storing section and the separator;
a dispenser comprising an aspirating nozzle to which the pipette tip separated by the separator is attachable, and for dispensing a sample with the pipette tip attached to the aspirating nozzle; and
an analyzing section for analyzing the sample dispensed by the dispenser.
